(19) United States
(12) Patent Application Publication
(10) Pub. No.: US 2006/0262569 A1
(43) Pub. Date: Nov. 23, 2006

(54) Backlight assembly and display device having the same

(75) Inventors: Joong-Hyun Kim, Suwon-si (KR); Seong-Sik Choi, Seoul (KR); In-Sun Hwang, Suwon-si (KR)

Correspondence Address: MACPHERSON KWOK CHEN & HEID LLP, 1762 TECHNOLOGY DRIVE, SUITE 226, SAN JOSE, CA, 95110, US

(73) Assignee: Samsung Electronics Co., Ltd.

(21) Appl. No.: 11/323,124

(22) Filed: Dec. 30, 2005

(30) Foreign Application Priority Data
May 19, 2005 (KR) 2005-41974

(51) Int. Cl. G02F 1/1335

(52) U.S. Cl. 362/626; 362/607; 362/561

(57) ABSTRACT

A light guide apparatus includes a reflecting polarizing surface and a light reflecting surface having at least one prism pattern thereon. The light guide apparatus may improve image display quality and manufacturing cost. For example, a backlight assembly includes a lamp, a light guiding plate and a reflecting sheet. The light guiding plate includes a light incident surface, a light reflecting surface and a light exiting surface. The light generated from the lamp is incident into the light incident surface. The light reflecting surface is extended from a side of the light incident surface. A plurality of first prism patterns is formed on the light reflecting surface. The light exiting surface is extended from another side of the light incident surface to correspond to the light reflecting surface. A reflective polarizing layer is formed on the light exiting surface. The reflecting sheet is on the light reflecting surface.

### CROSS REFERENCE TO RELATED APPLICATION

The present application claims priority from Korean Patent Application No. 2005-41974, filed on May 19, 2005, the disclosure of which is hereby incorporated herein by reference in its entirety.

### BACKGROUND OF THE INVENTION

1. Field of the Invention

The present invention relates to a backlight assembly and a display device having the backlight assembly. More particularly, the present invention relates to a backlight assembly capable of improving image display quality of a display device and decreasing the manufacturing cost for a backlight assembly, as well as a display device incorporating the backlight assembly.

2. Description of the Related Art

A liquid crystal display (LCD) device, in general, displays an image using a liquid crystal material that has an optical characteristic such as anisotropy of refractivity, as well as an electrical characteristic such as anisotropy of dielectric constant. The LCD device has a number of advantageous characteristics compared to other display devices such as cathode ray tube (CRT) devices, plasma display panel (PDP) devices, etc. For example, LCD devices may be thinner, have a lower driving voltage, lower power consumption, etc. than other device types. As a result, LCD devices are used in various fields.

An LCD device includes an LCD panel having a thin film transistor (TFT) substrate, a color filter substrate and a liquid crystal layer. The color filter substrate corresponds to the TFT substrate. The liquid crystal layer is interposed between the TFT substrate and the color filter substrate. In order to display an image, light transmittance of the liquid crystal layer is changed by generating an electric field in the liquid crystal layer. The LCD device is non-emissive type display device. Therefore, a backlight assembly may be used to supply the LCD panel of the LCD device with light.

A conventional backlight assembly includes a lamp and a light guiding plate. The lamp generates light. The light guiding plate guides the light generated by the lamp toward the LCD panel. The backlight assembly further includes optical sheets such as a diffusion sheet, a prism sheet, a reflective polarizing film, etc., on the light guiding plate to increase luminance and luminance uniformity (measured when the display is viewed on a plane).

Increasing the number of optical sheets may both increase the manufacturing cost of the backlight assembly is increased, and decrease its luminance of the light. In addition, a moire may be formed by optical interference between the optical sheets, which may cause the image display quality of the LCD device to deteriorate.

### SUMMARY OF THE INVENTION

The present invention provides a backlight assembly capable of improving the image display quality and decreasing the manufacturing cost of a display device incorporating the backlight assembly.

The present invention also provides a display device having the above-mentioned backlight assembly.

In general, in one aspect a light guide apparatus comprises a light reflecting surface positioned to receive light, the light reflecting surface including a first prism pattern comprising a plurality of prism features extending in a first direction. The light guide apparatus further includes a light transmission surface positioned opposite the light reflecting surface. The light transmission surface may be configured to substantially transmit light having a first polarization state and configured to substantially reflect light having a second different polarization state. The light guide apparatus may be included in a backlight assembly. The prism features may extend in a convex configuration from the light reflecting surface, and/or may be at least partially recessed configuration with respect to the light reflecting surface. The prism features include a portion having a substantially triangular cross section, and/or may include a portion having a curved cross section. The first prism pattern may be adjacent a region of the light receiving surface having a first shape. The first shape may include at least one curve portion (e.g., may be a dot shape), and/or may include at least one straight region.

A backlight assembly including the light guiding apparatus may include a lamp positioned proximate to a light receiving surface of the light guiding apparatus, wherein the lamp extends in a longitudinal direction, and wherein the longitudinal direction is substantially parallel to the first direction.

A backlight assembly in accordance with one embodiment of the present invention includes a lamp, a light guiding plate and a reflecting sheet. The lamp generates light. The light guiding plate includes a light incident surface, a light reflecting surface and a light exiting surface. The light generated from the lamp is incident into the light incident surface. The light reflecting surface extends from a side of the light incident surface. A plurality of first prism patterns that may have a dot shape is formed on the light reflecting surface. The light exiting surface extends from another side of the light incident surface to correspond to the light reflecting surface. A reflective polarizing layer is formed on the light exiting surface. A reflecting sheet may be positioned on the light reflecting surface.

The reflective polarizing layer may include a dual brightness enhancement film (DBEF) that transmits a P-wave portion of the light, and reflects an S-wave portion of the light. The reflective polarizing layer may include a cholesteric liquid crystal (CLC) film that transmits a portion of the light having a predetermined wavelength range, and reflects a remaining portion of the light.

Each of the first prism patterns may include a plurality of first prisms that have a substantially triangular cross-section, and each of the first prisms may extend in a substantially longitudinal direction of the lamp.

The light guiding plate may further include a second prism pattern on the reflective polarizing layer. The second prism pattern may include a plurality of second prisms that have a substantially triangular cross-section, and each of the second prisms may be substantially perpendicular to a longitudinal direction of the lamp.

A liquid crystal display device in accordance with one embodiment of the present invention includes a backlight assembly and a display unit. The backlight assembly includes a lamp, a light guiding plate and a reflecting sheet. T he lamp generates light. The light guiding plate includes a light incident surface, a light reflecting surface and a light exiting surface. The light generated from the lamp is incident into the light incident surface. The light reflecting surface extends from a side of the light incident surface. A plurality of first prism patterns that may have a dot shape is formed on the light reflecting surface. The light exiting surface extends from another side of the light incident surface to correspond to the light reflecting surface. A reflective polarizing layer is formed on the light exiting surface. The reflecting sheet may be positioned on the light reflecting surface. The display unit includes a liquid crystal display panel and a driving circuit part. The liquid crystal display panel displays an image using the light generated from the backlight assembly. The driving circuit part generates a control signal to drive the liquid crystal display panel.

The liquid crystal display panel may include a first substrate, a second substrate, a liquid crystal layer, a first polarizer and a second polarizer. The first substrate corresponds to the backlight assembly. The second substrate corresponds to the first substrate. The liquid crystal layer is interposed between the first and second substrates. The first polarizer is on the first substrate. The second polarizer is on the second substrate.

A polarizing axis of the reflective polarizing layer may be substantially in parallel with a polarizing axis of the first polarizer.

According to the present disclosure, a prism pattern having a shape such as a dot shape and the reflective polarizing layer are formed on the light reflecting surface and the light exiting surface of the light guiding plate, respectively, so that one or more optical sheets may be omitted, thereby decreasing the manufacturing cost of the backlight assembly. In addition, the image display quality of the LCD device is improved.

### BRIEF DESCRIPTION OF THE DRAWINGS

The above and other advantages of the present invention will become more apparent by describing in detail exemplary embodiments thereof with reference to the accompanying drawings, in which:

FIG. 1 is an exploded perspective view showing a backlight assembly in accordance with one embodiment of the present invention;

FIG. 2 is a cross-sectional view showing the backlight assembly shown in FIG. 1;

FIG. 3 is a cross-sectional view showing a reflective polarizing layer shown in FIG. 2;

FIG. 4 is a cross-sectional view showing a reflective polarizing layer in accordance with another embodiment of the present invention;

FIG. 5 is a plan view showing a liquid crystal layer shown in FIG. 4;

FIG. 6 is a plan view showing a light reflecting surface of a light guiding plate shown in FIG. 1;

FIG. 7 is a cross-sectional view taken along a line I-I′ shown in FIG. 6;

FIG. 8 is a cross-sectional view showing a first prism pattern of a light guiding plate in accordance with another embodiment of the present invention;

FIG. 9 is a perspective view showing a light guiding plate in accordance with another embodiment of the present invention;

FIG. 10 is a cross-sectional view taken along a line II-II′ shown in FIG. 9;

FIG. 11 is an exploded perspective view showing a liquid crystal display (LCD) device in accordance with one embodiment of the present invention; and

FIG. 12 is a cross-sectional view showing the LCD device shown in FIG. 11.

### DETAILED DESCRIPTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully describe the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The description of an element as “first” does not imply that “second” or additional elements are necessary.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

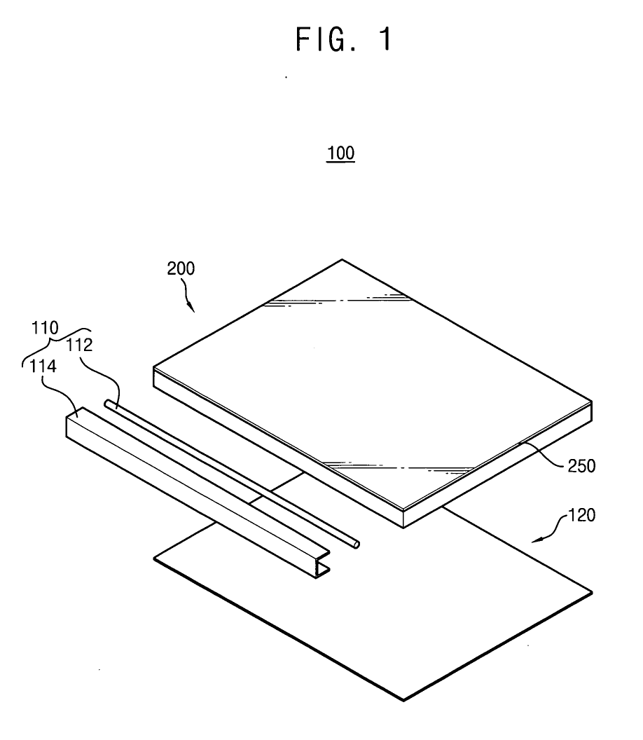

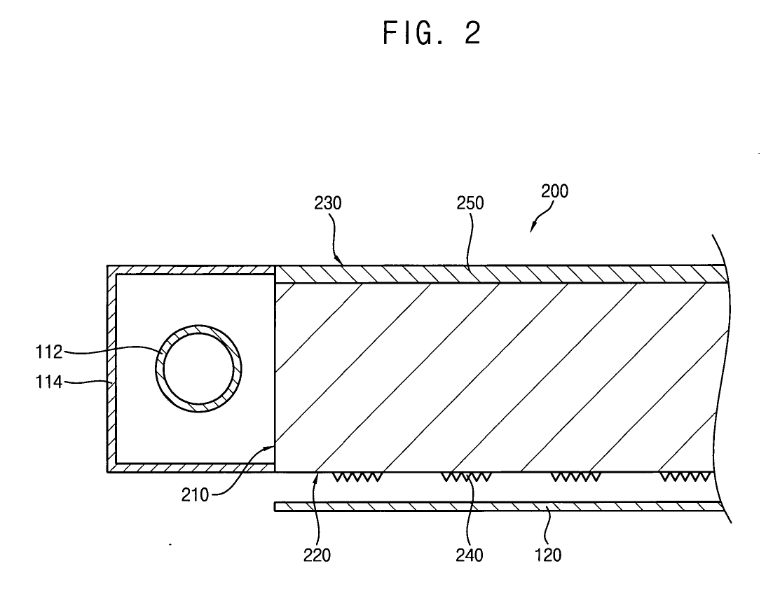

FIG. 1 is an exploded perspective view showing a backlight assembly in accordance with one embodiment of the present invention. FIG. 2 is a cross-sectional view showing the backlight assembly shown in FIG. 1.

Referring to FIGS. 1 and 2, the backlight assembly 100 includes a lamp unit 110, a light guiding plate 200 and a reflecting sheet 120.

The lamp unit 110 includes a lamp 112 and a lamp cover 114. The lamp unit 110 is on a side of the light guiding plate 200. Alternatively, two lamp units 110 may be on opposite sides of the light guiding plate 200.

At least one lamp 112 is in the lamp cover 114. The lamp 112 generates a light based on an electric power generated, for example, by an externally provided inverter (not shown). For example, the lamp 112 may be a cold cathode fluorescent lamp (CCFL) that has an extended cylindrical shape. Alternatively, the lamp 112 may be an external electrode fluorescent lamp (EEFL) that has an external electrode on an outer surface of the EEFL.

The lamp cover 114 covers three adjacent sides of the lamp 112 to protect the lamp 112. The lamp cover 114 includes a highly reflective material. In some embodiments, highly reflective material may be coated on an inner surface of the lamp cover 114. The light generated from the lamp 112 is reflected from the lamp cover 114 toward the light guiding plate 200 to increase a luminance of the backlight assembly 100.

The light guiding plate 200 guides the light generated from the lamp unit 110 toward a front of the backlight assembly 100. The light guiding plate 200 includes a transparent material. For example, the light guiding plate 200 includes polymethylmethacrylate (PMMA).

The light guiding plate 200 includes a light incident surface 210, a light reflecting surface 220, and a light exiting surface 230. The light reflecting surface 220 protrudes from a side of the light incident surface 210. The light exiting surface 230 extends from another surface of the light incident surface 210, and corresponds to the light reflecting surface 220.

A plurality of first prism patterns 240 is formed on the light reflecting surface 220 of the light guiding plate 200. In the embodiment shown, each of the first prism patterns 240 has a dot shape. The light that is incident into the light guiding plate 200 through the light incident surface 210 is reflected and modulated by the first prism patterns 240. As a result, a portion of the modulated light having an incident angle larger than a predetermined critical angle exits from the light exiting surface 230 and the light reflecting surface 220 of the light guiding plate 200.

The first prism pattern 240 is formed on the light reflecting surface 220 of the light guiding plate 200 through an injection molding process, a stamping process, a molding process, etc.

A reflective polarizing layer 250 is formed on the light exiting surface 230 of the light guiding plate 200. The reflective polarizing layer transmits a portion of the light that is incident on the reflective polarizing layer 250, and a remaining portion of the light that is incident on the reflective polarizing layer 250 is reflected from the reflective polarizing layer 250. In FIGS. 1 and 2, the transmission and the reflection of the reflective polarizing layer 250 are determined by a polarizing axis of the light that is incident on the reflective polarizing layer 250. Therefore, the remaining portion of the light is recycled to increase the luminance of the backlight assembly 100.

The reflective polarizing layer 250 includes a polarizing axis that has a transmitting direction and a reflecting direction. For example, the reflecting direction is substantially perpendicular to the transmitting direction. The polarizing axis of the reflective polarizing layer 250 may be substantially parallel to a polarizing axis of a polarizer (not shown) on a lower surface of an LCD panel (not shown).

The reflecting polarizing layer 250 may be a dual brightness enhancement film (DBEF), a cholesteric liquid crystal (CLC) film, metal grid polarizer (MGP) film, etc. The DBEF transmits a P-wave portion of the light that is incident on the DBEF, and a S-wave portion of the light that is incident on the DBEF is reflected from the DBEF. The CLC film transmits a portion of the incident light having a predetermined wavelength range, and a remaining portion of the incident light is reflected from the CLC film. The MGP film includes a plurality of metal portions arranged with a substantially constant separation interval.

For example, the reflective polarizing layer 250 is attached to the light exiting surface 230 of the light guiding plate 200 using an adhesive. A haze value of the adhesive may be substantially zero so that the adhesive transmits substantially 100% of the light that is incident into the adhesive.

The reflecting sheet 120 is on the light reflecting surface 220 of the light guiding plate 200. The light that is incident on the reflecting sheet 120 is reflected from the reflecting sheet 120 toward the light exiting surface 230. The reflecting sheet 120 includes a highly reflective material. Examples of the highly reflective material that can be used for the reflecting sheet 120 include polyethyleneterephthalate (PET), polycarbonate (PC), etc.

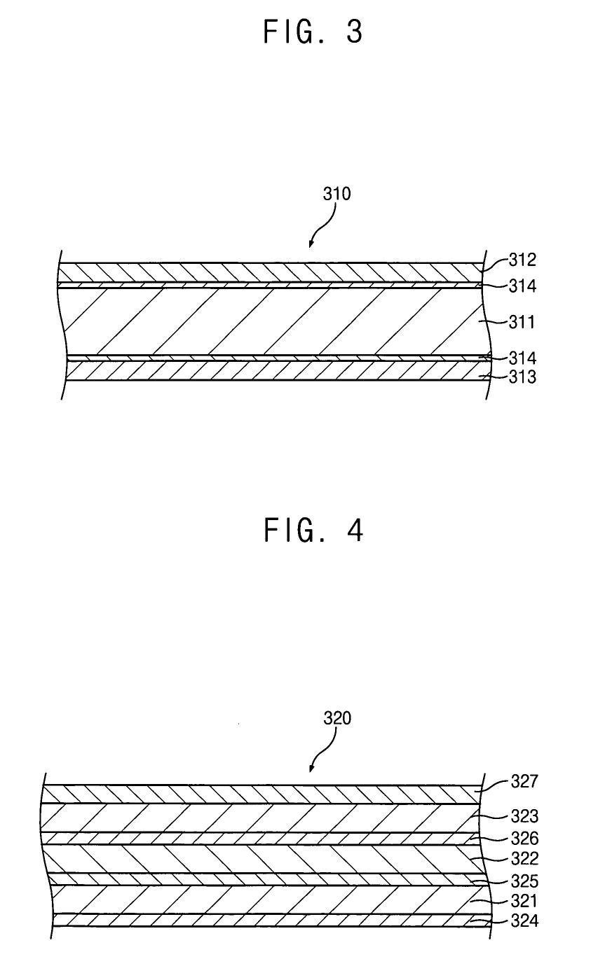

FIG. 3 is a cross-sectional view showing a reflective polarizing layer shown in FIG. 2.

Referring to FIG. 3, a reflecting polarizing layer such as layer 250 of FIG. 2 includes the DBEF 310 that transmits the P-wave portion of the light that is incident on the DBEF 310, and reflects the S-wave portion of the light that is incident on the DBEF 310.

The DBEF 310 includes a polarizing layer 311, a first protecting layer 312 and a second protecting layer 313. The first and second protecting layers 312 and 313 are on an upper surface and a lower surface of the polarizing layer 311. For example, the first and second protecting layers 312 and 313 a reattached to the upper and lower surfaces of the polarizing layer 311, respectively, using an ultraviolet curable adhesive 314.

The polarizing layer 311 has a multi-layered structure that includes a plurality of anisotropic thin films. For example, a large number of thin films (on the order of hundreds or thousands of anisotropic thin films) are stacked to form the polarizing layer 311. The first and second protecting layers 312 and 313 are attached to the upper and lower surfaces of the polarizing layer 311, respectively, to protect the polarizing layer 311.

The polarizing layer 311 transmits the portion of the light that is polarized along the polarizing axis, and the remaining portion of the light that is polarized in a different direction to the polarizing axis is reflected from the polarizing layer 311. For example, the polarizing layer 311 transmits the P-wave portion, and the S-wave portion is reflected from the polarizing layer 311. The S-wave portion that is reflected from the reflective polarizing layer 311 is again reflected by the light reflecting surface 220 and the reflecting sheet 130, and changed into a mixture of the P-wave portion and the S-wave portion to be incident again onto the DBEF film 310. The above-mentioned processes are repeated so that substantially all of the light generated from the lamp 112 passes through the DBEF film 310, thereby increasing the luminance of the backlight assembly 100.

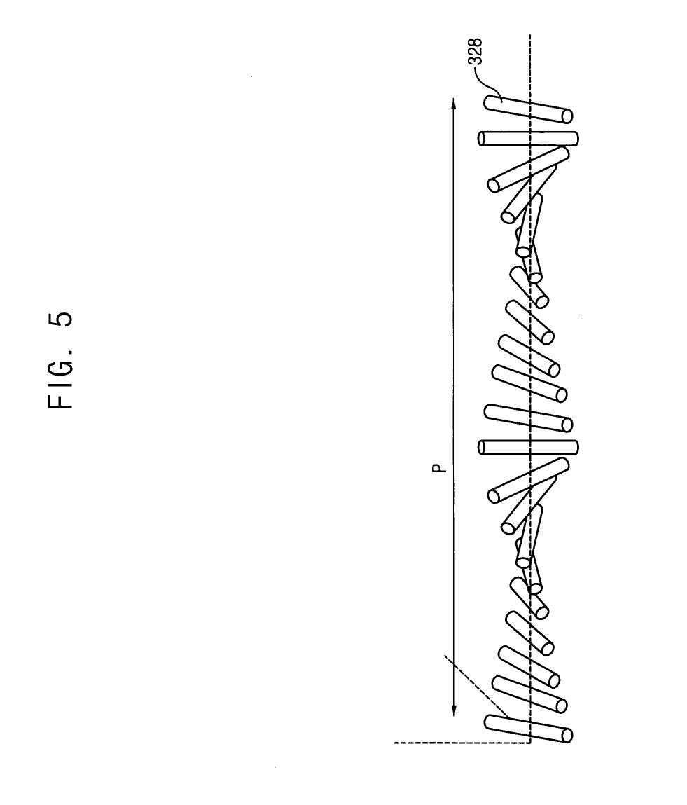

FIG. 4 is a cross-sectional view showing a reflective polarizing layer in accordance with another embodiment of the present invention. FIG. 5 is a plan view showing a liquid crystal layer shown in FIG. 4.

Referring to FIGS. 4 and 5, a reflective polarizing layer such as layer 250 of FIG. 2 includes a CLC film 320 that transmits a portion of the incident light having a predetermined wavelength range, and reflects a remaining portion of the incident light from the CLC film 320.

The CLC film 320 includes a first liquid crystal layer 321, a second liquid crystal layer 322, a third liquid crystal layer 323, a first base film 324, a second base film 325, a third base film 326 and a retardation film 327.

The first, second and third base films 324, 325 and 326 and the first, second and third liquid crystal layers 321, 322 and 323 are alternately stacked, and the retardation film 327 is on the stacked structure. The first, second and third base films 324, 325 and 326 may include polyethyleneterephthlate (PET).

The first, second and third liquid crystal layers 321, 322 and 323 include an ultraviolet curable liquid crystal. A monomer layer is coated, and the coated monomer layer is irradiated with ultraviolet light to form each of the first, second and third liquid crystal layers 321, 322 and 323 as a polymer film.

Each of the first, second and third liquid crystal layers 321, 322 and 323 includes a cholesteric liquid crystal 328 that has a plurality of rod shaped liquid crystal molecules, and the rod shaped liquid crystal molecules of the cholesteric liquid crystal 328 form a spiral shape. The liquid crystal molecules of the cholesteric liquid crystal 328 are twisted in a predetermined pitch P.

The first, second and third liquid crystal layers 321, 322 and 323 have different pitches P to one another. For example, a pitch P of the first liquid crystal layer 321 corresponds to a wavelength of a red light. A pitch P of the second liquid crystal layer 322 corresponds to a wavelength of a green light. A pitch P of the third liquid crystal layer 323 corresponds to a wavelength of a blue light. The wavelength of each of the red, green and blue lights is substantially equal to a product of the pitch P of each of the first, second and third liquid crystal layers 321, 322 and 323 by a refractive index n of the cholesteric liquid crystal 328. The portion of the light that is polarized in the twisted direction of the cholesteric liquid crystal 328 is reflected from the first, second and third liquid crystal layers 321, 322 and 323, and the first, second and third liquid crystal layers 321, 322 and 323 transmit the remaining portion of the light.

When the cholesteric liquid crystal 328 is twisted in a right direction, the portion of the light that is reflected from each of the first, second and third liquid crystals 321, 322 and 323 is circularly polarized in the right direction, and the remaining portion of the light that has passed through the cholesteric liquid crystal 328 is circularly polarized in a left direction. When the cholesteric liquid crystal 328 is twisted in the left direction, the portion of the light that is reflected from each of the first, second and third liquid crystals 321, 322 and 323 is circularly polarized in the left direction, and the remaining portion of the light that has passed through the cholesteric liquid crystal 328 is circularly polarized in the right direction. The reflected light that is reflected from each of the first, second and third liquid crystal layers 321, 322 and 323 is reflected again from the light reflecting surface 220 and the reflecting sheet 120. The above-mentioned processes are repeated so that substantially all of the light generated from the lamp 112 passes through the CLC film 320, and the light that has passed through the CLC 320 is circularly polarized in a same direction.

When the circularly polarized light is directly incident into an LCD panel (not shown) that displays an image, a luminance of the light is decreased by a polarizer that is attached on the LCD panel. In FIGS. 4 and 5, the retardation film 327 is on the CLC film 320 so that the circularly polarized light that has passed through the first, second and third liquid crystal layers 321, 322 and 323 is linearly polarized. For example, the retardation film 327 is a λ/4 phase delay film.

Alternatively, the CLC film 320 may have a plurality of liquid crystal layers from which light having various wavelengths is reflected so that the CLC film 320 may correspond to substantially the entire spectrum of visible light.

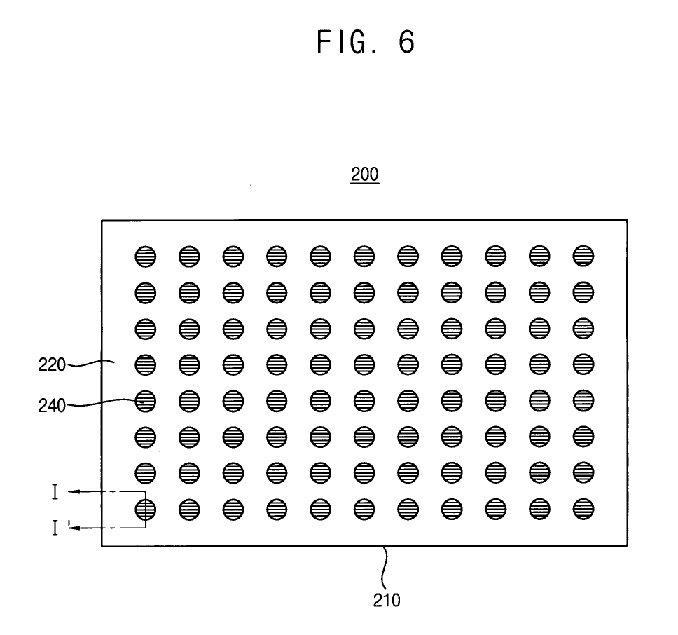

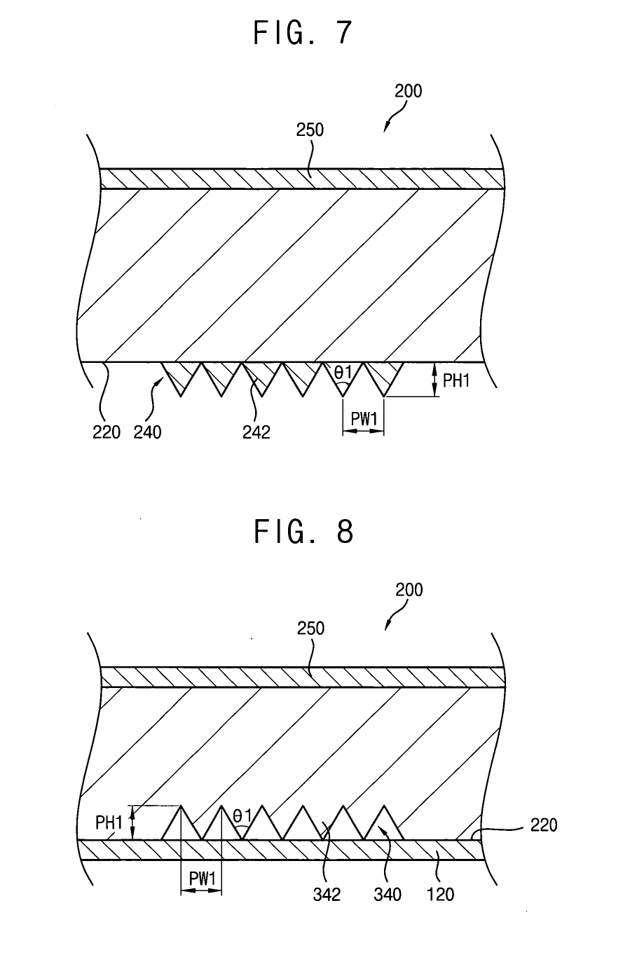

FIG. 6 is a plan view showing a light reflecting surface of a light guiding plate shown in FIG. 1. FIG. 7 is a cross-sectional view taken along a line I-I′ shown in FIG. 6.

Referring to FIGS. 6 and 7, a plurality of first prism patterns 240 having a dot shape is formed on the light reflecting surface 220 of the light guiding plate 200. Each of the first prism patterns 240 has a substantially circular shape when viewed on a plane. Alternatively, each of the first prism patterns 240 may have a different shape such as a polygonal shape such as a quadrangular shape, a pentagonal shape, etc.

Each of the first prism patterns 240 protrudes from the light reflecting surface 220 to form a convex shape.

Each of the first prism patterns 240 includes a plurality of first prisms 242 that are adjacent to one another. Alternatively, each of the first prisms 242 may be spaced apart from each other. Each of the first prisms 242 is extended in a substantially longitudinal direction of the lamp 112.

Each of the first prisms 242 has a substantially triangular cross-section. A first pitch PW1 of the first prisms 242 is about 10 μm to about 100 μm. A first corner angle θ1 of each of the first prisms 242 is about 60° to about 120°. For example, the first pitch PW1 and a first height PH1 of each of the first prisms 242 are about 50 μm and about 25 μm, respectively, and the first corner angle θ1 of each of the first prisms 242 is about 800 to about 90 °.

Alternatively, each of the first prisms 242 may have a rounded corner (corresponding to the corner angle θ1). Each of the first prisms 242 may also have a curved cross-section such as a substantially semi-elliptical cross-section or a substantially semi-circular cross-section.

The first prism patterns 240 may have substantially the same size, and may be substantially uniformly distributed on the light reflecting surface 220 (as shown in FIG. 6). Alternatively, the first prism patterns 240 may have various sizes, and may be arranged in response to luminance of locations of the first prism patterns 240. For example, the sizes and densities of the first prism patterns 240 may be increased as the distance from the light incident surface 210 is increased, so that the amount of reflected light is increased.

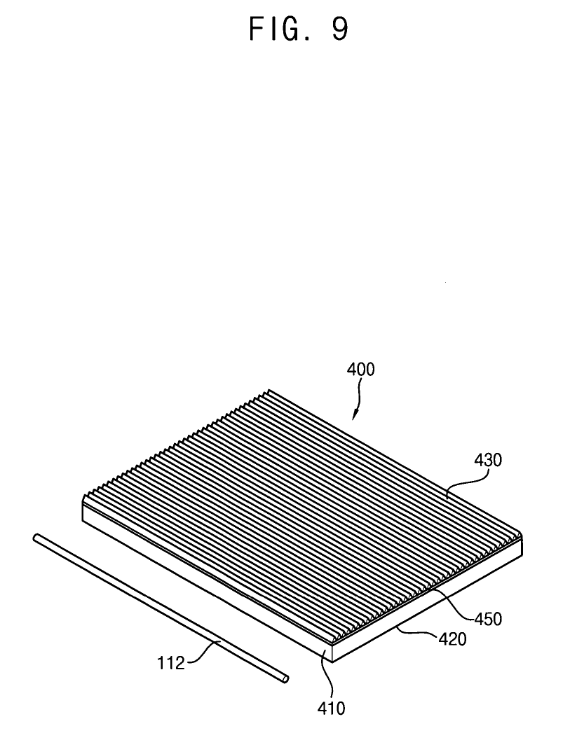

FIG. 8 is a cross-sectional view showing a first prism pattern of a light guiding plate in accordance with another embodiment of the present invention.

Referring to FIG. 8, a plurality of first prism patterns 340 having a dot shape is formed on the light reflecting surface 220 of the light guiding plate 200. Each of the first prism patterns 340 has a substantially circular shape when viewed on a plane. Alternatively, each of the first prism patterns 340 may have a different shape such as a polygonal shape such as a quadrangular shape, a pentagonal shape, etc.

Each of the first prism patterns 340 is recessed from the light reflecting surface 220 to form a concave shape.

Each of the first prism patterns 340 includes a plurality of first prisms 342 that are adjacent to one another. Alternatively, each of the first prisms 342 may be spaced apart from one another. Each of the first prisms 342 extends in a substantially longitudinal direction of the lamp 112.

Each of the first prisms 342 has a substantially triangular cross-section. A first pitch PW1 of the first prisms 342 is about 10 μm to about 100 μm. A first corner angle θ1 of each of the first prisms 342 is about 60° to about 120°. For example, the first pitch PW1 and a first height PH1 of each of the first prisms 342 are about 50 μm and about 25 μm, respectively, and the first corner angle θ1 of each of the first prisms 342 is about 80° to about 90 °.

Alternatively, each of the first prisms 342 may have a rounded corner Each of the first prisms 342 may also have a substantially semi-elliptical cross-section or a substantially semi-circular cross-section.

The first prism patterns 340 may have substantially the same size, and may be substantially uniformly distributed on the light reflecting surface 220. Alternatively, the first prism patterns 340 may have various sizes, and may be arranged in response to luminance of locations of the first prism patterns 340. For example, the sizes and densities of the first prism patterns 340 may be increased as the distance from the light incident surface 210 is increased, so that the amount of reflected light is increased.

In FIG. 8, when the first prism patterns 340 have a concave shape, a reflecting sheet 120 may be attached to the light reflecting surface 220 of the light guiding plate 200. Since a plurality of sheets is integrally formed with the light guiding plate 200, the number of sheets is decreased. The occurrence of a moire, which may accompany the use of multiple sheets, may also be reduced or eliminated.

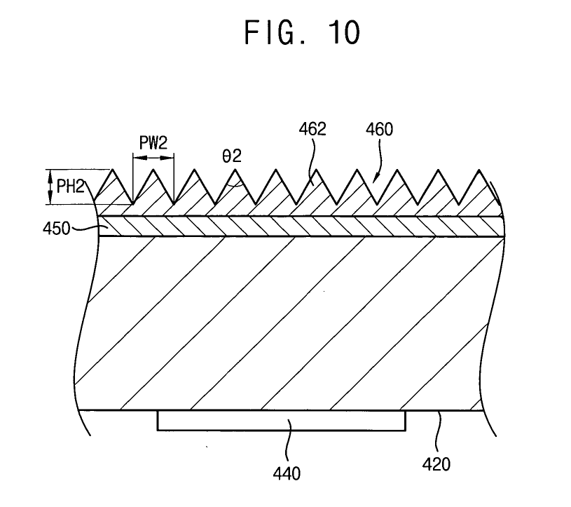

FIG. 9 is a perspective view showing a light guiding plate in accordance with another embodiment of the present invention. FIG. 10 is a cross-sectional view taken along a line II-II′ shown in FIG. 9.

Referring to FIGS. 9 and 10, the light guiding plate 400 includes a light incident surface 410, a light reflecting surface 420 and a light exiting surface 430. A light generated from a lamp 112 is incident into the light incident surface 410. The light reflecting surface 420 protrudes from a side of the light incident surface 410. The light exiting surface 430 extends from another surface of the light incident surface 410, and corresponds to the light reflecting surface 420.

A plurality of first prism patterns 440 is formed on the light reflecting surface 420 of the light guiding plate 400. Each of the first prism patterns 440 has a dot shape. The light that is incident into the light guiding plate 400 through the light incident surface 410 is reflected and modulated by the first prism patterns 440, and a portion of the modulated light having an incident angle larger than a predetermined critical angle exits from the light exiting surface 430 and the light reflecting surface 420 of the light guiding plate 400.

The first prism patterns 440 of FIGS. 9 and 10 are same as the first prism patterns shown in FIGS. 6 to 8. Thus, further explanation concerning the above elements will be omitted.

A reflective polarizing layer 450 is formed on the light exiting surface 430 of the light guiding plate 400. The reflective polarizing layer 450 transmits a portion of the light that is incident on the reflective polarizing layer 450, and a remaining portion of the light that is incident on the reflective polarizing layer 450 is reflected from the reflective polarizing layer 450. Therefore, the remaining portion of the light is recycled to increase the luminance of the backlight assembly.

The reflecting polarizing layer 450 may be a dual brightness enhancement film (DBEF), a cholesteric liquid crystal (CLC) film, metal grid polarizer (MGP) film, etc. The DBEF transmits a P-wave portion of the light that is incident on the DBEF, and reflects a S-wave portion of the light that is incident on the DBEF. The CLC film transmits a portion of the light having a predetermined wavelength, and reflects a remaining portion of the light that is incident on the CLC film. The MGP film includes a plurality of metal portions arranged with a predetermined separation interval. The DBEF and CLC of FIGS. 9 and 10 are same as in FIGS. 3 to 5. Thus, further explanation concerning the above elements will be omitted.

The light guiding plate 400 may further include a plurality of second prism patterns 460 that are formed on the reflective polarizing layer 450. The second prism patterns 460 may be disposed across all of the light exiting surface 430 to increase a luminance of the light that exits from the second prism patterns 460 when viewed on a plane.

Each of the second prism patterns 460 includes a plurality of second prisms 462 that are adjacent to one another. Alternatively, each of the second prisms 462 may be spaced apart from one another. Each of the second prisms 462 extends in a direction substantially perpendicular to a longitudinal direction of the lamp 112. That is, the first prism patterns 440 are substantially perpendicular to the second prism patterns 460.

Each of the second prisms 462 has a substantially triangular cross-section. A second pitch PW2 of the second prisms 462 is about 50 μm to about 150 μm. A second corner angle θ2 of each of the second prisms 462 is about 60° to about 120°. For example, the second pitch PW2 and a second height PH2 of each of the second prisms 462 are about 100 μm and about 50 μm, respectively, and the second corner angle θ2 of each of the second prisms 462 is about 80° to about 90 °.

Alternatively, each of the second prisms 462 may have a rounded corner Each of the second prisms 462 may also have a substantially semi-elliptical cross-section or a substantially semi-circular cross-section.

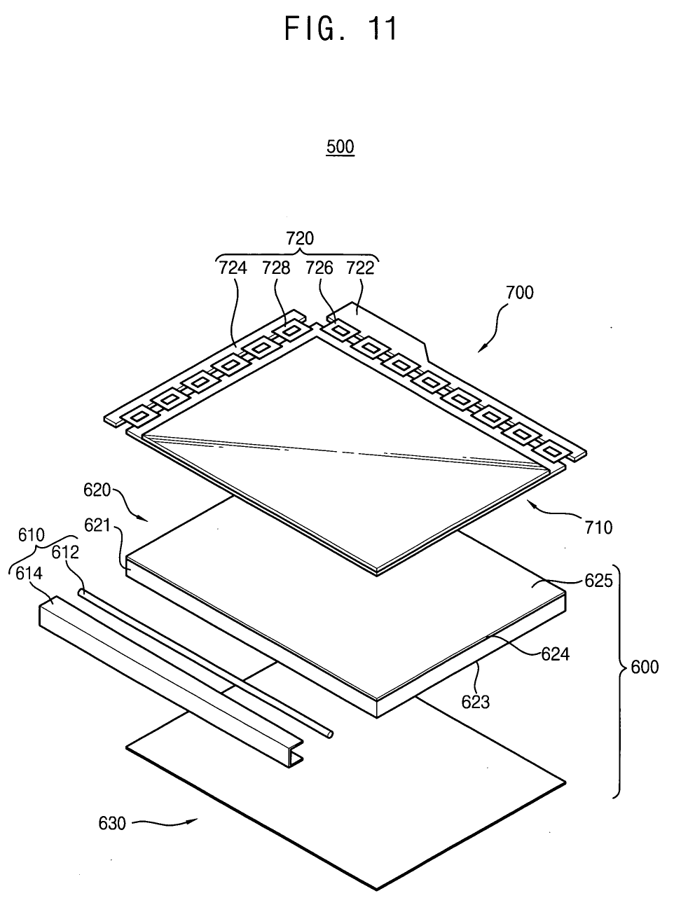

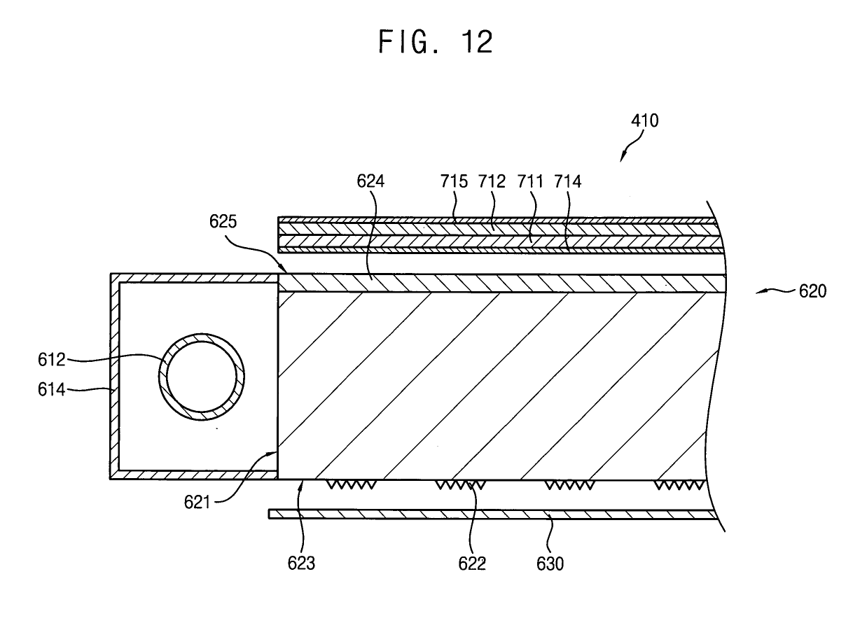

FIG. 11 is an exploded perspective view showing a liquid crystal display (LCD) device in accordance with one embodiment of the present invention. FIG. 12 is a cross-sectional view showing the LCD device shown in FIG. 11.

Referring to FIGS. 11 and 12, the LCD device 500 includes a backlight assembly 600 and a display unit 700. The backlight assembly 600 generates light. The display unit 700 displays an image using the generated light.

The backlight assembly 600 includes a lamp unit 610, a light guiding plate 620, and a reflecting sheet 630. The lamp unit 610 includes a lamp 612 and a lamp cover 614. The lamp 612 generates light. The light guiding plate 620 includes a light incident surface 621, a light reflecting surface 623 and a light exiting surface 625. The light generated by the lamp 612 is incident into the light guiding plate 620 through the light incident surface 621. The light reflecting surface 623 extends from a side of the light incident surface 621, and a plurality of first prism patterns 622 having a dot shape is formed on the light reflecting surface 623. The light exiting surface 625 extends from another side of the light incident surface 621, and corresponds to the light reflecting surface 623. A reflective polarizing layer 624 is formed on the light exiting surface 625. The light guiding plate 620 may further include a second prism pattern (not shown) on the reflective polarizing layer 624. A reflecting sheet 630 is on the light reflecting surface 623.

The backlight assembly 600 illustrated in FIGS. 11 and 12 may be one in FIGS. 1 to 10. Thus, further explanation concerning the above elements will be omitted.

The display unit 700 includes a liquid crystal display (LCD) panel 710 and a driving circuit part 720. The LCD panel 710 displays an image using the light generated from the backlight assembly 600. The driving circuit part 720 generates a control signal to drive the LCD panel 710.

The LCD panel 710 includes a first substrate 711, a second substrate 712 and a liquid crystal layer (not shown). The first substrate 711 corresponds to the backlight assembly 600. The second substrate 712 corresponds to the first substrate 711. The liquid crystal layer (not shown) is interposed between the first and second substrates 711 and 712. The LCD panel 710 may further include a first polarizer 714 on the first substrate 711 and a second polarizer 715 on the second substrate 712.

The first substrate 711 includes a plurality of thin film transistors (TFT) that are arranged in a matrix shape. For example, the first substrate 711 includes a transparent glass material. A source electrode and a gate electrode of each of the TFTs are electrically connected to a data line and a gate line, respectively. A drain electrode of each of the TFT is electrically connected to a pixel electrode that comprises a transparent conductive material.

The second substrate 712 is a color filter substrate that has red, green and blue pixels. For example, the second substrate 712 includes a transparent glass material. The second substrate 712 may further include a common electrode that comprises a transparent conductive material. Alternatively, the red, green and blue pixels may be formed on the first substrate 711.

When electric power is applied to the gate electrode of the TFT, the TFT is turned on so that an electric field is formed between the pixel electrode (not shown) and the common electrode (not shown). Molecules of a liquid crystal in the liquid crystal layer (not shown) that is interposed between the first and second substrates 711 and 712 vary their arrangement in response to the local electric field applied thereto, and thus a light transmittance thereof may be changed to display an image.

Each of the first and second polarizers 714 and 715 polarizes the light along a polarizing axis. That is, each of the first and second polarizers 714 and 715 has a transmitting direction and a reflecting direction that is substantially perpendicular to the transmitting direction. In FIGS. 11 and 12, the polarizing axis of the first polarizer 714 that is attached to the first substrate 711 is substantially perpendicular to the polarizing axis of the second polarizer 715.

In FIGS. 11 and 12, the polarizing axis of the reflective polarizing layer 624 on the light exiting surface 625 of the light guiding plate 620 is substantially parallel to the polarizing axis of the first polarizer 714, to increase a luminance of the backlight assembly 600. For example, more than about 60% of the light that exits from the light guiding plate 620 is polarized and passes through the reflective polarizing layer 624. That is, when the polarizing axis of the reflective polarizing layer 624 is substantially parallel to the polarizing axis of the first polarizer 714, the efficiency of the backlight assembly 600 may be no less than about 60%.

The driving circuit member 720 includes a data printed circuit board (PCB) 722 and a gate PCB 724. The data PCB 722 applies a data driving signal to the LCD panel 710. The gate PCB 724 applies a gate driving signal to the LCD panel 710.

The driving circuit member 720 may further include a data flexible circuit film 726 and a gate flexible film 728. The data PCB 722 is electrically connected to the LCD panel 710 through the data flexible circuit film 726. The gate PCB 724 is electrically connected to the LCD panel 710 through the gate flexible circuit film 728. Each of the data and gate flexible circuit films 726 and 728 may be a tape carrier package (TCP) or a chip on film (COF).

Alternatively, signal lines (not shown) may be directly formed on the LCD panel 710 and the gate flexible circuit film 728 so that the gate PCB 724 may be omitted.

According to the present disclosure, a prism pattern having a dot shape may be formed on a light reflecting surface of a light guiding plate, and a reflective polarizing layer may be formed on a light exiting surface of the light guiding plate. As a result, one or more optical sheets may be omitted, thereby decreasing the manufacturing cost of the backlight assembly.

In addition, since some optical sheets are omitted, a moire that may be formed by the optical sheets may be prevented, which may improve the image display quality of the LCD device.

Furthermore, the polarizing axis of the reflective polarizing layer is substantially parallel to the polarizing axis of the lower polarizer, so that the light efficiency is increased.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A backlight assembly comprising:
a lamp configured to generate a light;
a light guiding plate including:
a light incident surface positioned to receive the light generated by the lamp;
a light reflecting surface extending from a side of the light incident surface, the light reflecting surface including a plurality of first prism patterns having a dot shaped interface with the light reflecting surface and positioned thereon; and
a light exiting surface extending from another side of the light incident surface positioned to correspond to the light reflecting surface, the light exiting surface including a reflective polarizing layer formed thereon; and
a reflecting sheet on the light reflecting surface.

2. The backlight assembly of claim 1, wherein the reflective polarizing layer comprises a dual brightness enhancement film (DBEF) that configured to transmit a P-wave portion of the light and to reflect an S-wave portion of the light.

3. The backlight assembly of claim 1, wherein the reflective polarizing layer comprises a cholesteric liquid crystal (CLC) film configured to transmit a portion of the light having a wavelength included in a predetermined wavelength range, and further configured to reflect a remaining portion of the light.

4. The backlight assembly of claim 1, wherein each of the first prism patterns comprises a plurality of first prisms having a substantially triangular cross-section.

5. The backlight assembly of claim 4, wherein the lamp extends in a longitudinal direction, and wherein each of the first prisms extends substantially in the longitudinal direction of the lamp.

6. The backlight assembly of claim 1, wherein each of the first prism patterns protrudes from the light reflecting surface to form a convex shape.

7. The backlight assembly of claim 1, wherein each of the first prism patterns is recessed from the light reflecting surface to form a concave shape.

8. The backlight assembly of claim 7, wherein the reflecting sheet is attached to the light reflecting surface.

9. The backlight assembly of claim 1, wherein the light guiding plate further comprises a second prism pattern on the reflective polarizing layer.

10. The backlight assembly of claim 9, wherein the second prism pattern comprises a plurality of second prisms that have a substantially triangular cross-section.

11. The backlight assembly of claim 10, wherein the lamp extends in a longitudinal direction, and wherein each of the second prisms is substantially perpendicular to the longitudinal direction of the lamp.

12. A liquid crystal display device comprising:
a backlight assembly including:
a lamp configured to generate a light;
a light guiding plate including:
a light incident surface positioned to receive the light generated by the lamp;
a light reflecting surface extending from a side of the light incident surface, the light reflecting surface including a plurality of first prism patterns having a dot shape interface with the light reflecting surface and positioned thereon; and
a light exiting surface extending from another side of the light incident surface positioned to correspond to the light reflecting surface, the light exiting surface including a reflective polarizing layer formed thereon; and
a reflecting sheet on the light reflecting surface; and
a display unit including:
a liquid crystal display panel configured to display an image using the light generated from the backlight assembly; and
a driving circuit part configured to generate a control signal to drive the liquid crystal display panel.

13. The liquid crystal display device of claim 12, wherein the liquid crystal display panel comprises:
a first substrate positioned corresponding to the backlight assembly to receive light from the backlight;
a second substrate positioned corresponding to the first substrate;
a liquid crystal layer interposed between the first and second substrates;
a first polarizer on the first substrate; and
a second polarizer on the second substrate.

14. The liquid crystal display device of claim 13, wherein a polarizing axis of the reflective polarizing layer is substantially parallel to a polarizing axis of the first polarizer.

15. The liquid crystal display device of claim 14, wherein the reflective polarizing layer comprises a dual brightness enhancement film (DBEF) configured to transmit a P-wave portion of the light and to reflect an S-wave portion of the light.

16. The liquid crystal display device of claim 14, wherein the reflective polarizing layer comprises a cholesteric liquid crystal (CLC) film configured to transmit a portion of the light having a predetermined wavelength range, and further configured to reflect a remaining portion of the light.

17. The liquid crystal display device of claim 12, wherein the lamp extends in a longitudinal direction, wherein each of the first prism patterns comprises a plurality of first prisms having a substantially triangular shape, and wherein the first prisms extends substantially in the longitudinal direction of the lamp.

18. The liquid crystal display device of claim 12, wherein each of the first prism patterns is recessed from the light reflecting surface to form a concave shape, and wherein the reflecting sheet is attached to the light reflecting surface.

19. The liquid crystal display device of claim 12, wherein the light guiding plate further comprises a second prism pattern on the reflective polarizing layer.

20. The liquid crystal display device of claim 19, wherein the lamp extends in a longitudinal direction, wherein the second prism pattern comprises a plurality of second prisms having a substantially triangular cross section, and wherein the second prisms are extended substantially perpendicular to the longitudinal direction of the lamp.

21. A light guide apparatus comprising:
a light reflecting surface positioned to receive light, the light reflecting surface including a first prism pattern comprising a plurality of prism features extending in a first direction;
a light transmission surface positioned opposite the light reflecting surface, the light transmission surface configured to substantially transmit light having a first polarization state and configured to substantially reflect light having a second different polarization state.

22. The apparatus of claim 21, wherein the prism features further extend in a convex configuration from the light reflecting surface.

23. The apparatus of claim 21, wherein the prism features are in an at least partially recessed configuration with respect to the light reflecting surface.

24. The apparatus of claim 21, wherein the prism features include a portion having a substantially triangular cross section.

25. The apparatus of claim 21, wherein the prism features include a portion having a curved cross section.

26. The apparatus of claim 21, wherein the light guiding apparatus is included in a backlight assembly including a light assembly.

27. The apparatus of claim 26, wherein the light assembly includes a lamp positioned proximate to a light receiving surface of the light guiding apparatus, wherein the lamp extends in a longitudinal direction, and wherein the longitudinal direction is substantially parallel to the first direction.

28. The apparatus of claim 21, wherein the first prism pattern adjacent a region of the light receiving surface having a first shape.

29. The apparatus of claim 28, wherein the first shape including at least one curve portion.

30. The apparatus of claim 29, wherein the first shape is a dot shape.

31. The apparatus of claim 28, wherein the first shape includes at least one straight region.
